(19) United States
(12) Patent Application Publication
(10) Pub. No.: US 2026/0257891 A1
(43) Pub. Date: Sep. 3, 2026

(54) STAIRLIFT DEVICE COMPRISING COLLISION PREVENTION MEANS AS WELL AS METHOD FOR COLLISION PREVENTION AND USE

(71) Applicant: TK HOME SOLUTIONS B.V., Krimpen aan den IJssel (NL)

(72) Inventor: Sjaak Wisse, Krimpen aan den IJssel (NL)

(21) Appl. No.: 18/878,373

(22) PCT Filed: Jun. 28, 2023
(86) PCT No.: PCT/EP2023/067553

§ 371 Date: Dec. 23, 2024

(30) Foreign Application Priority Data
Jun. 29, 2022 (EP) 22181757.0

(51) Int. Cl. B66B 9/08

(52) U.S. Cl. CPC B66B 9/0853

(57) ABSTRACT

The present disclosure relates to a stairlift device configured for collision detection based on at least one sensor unit integrated in the stairlift device, wherein the at least one sensor unit is configured and arranged for scanning the area surrounding the stairlift device or in travel direction and for detecting an object, wherein the stairlift device is configured for collision prevention based on sensor data of at least one sensor of the sensor unit, wherein the stairlift device exhibits a control unit coupled with the at least one sensor and with at least one drive or actuator of the stairlift device, wherein the stairlift device is configured for stopping or at least decelerating the at least one drive or actuator based on sensor data. The present disclosure further relates to a corresponding method for collision prevention in such stairlift devices.

### CROSS-REFERENCE TO RELATED APPLICATIONS

This application is Continution-In-Part of the U.S. National Phase of PCT/EP2023/067553 filed Jun. 28, 2023, which claims priority to European Patent Application No. 22181757.0, filed Jun. 29, 2022, the entire content of both are incorporated herein by reference in their entirety.

### TECHNICAL FIELD

The present disclosure refers to a stairlift device for collision detection and also active collision prevention based on at least one sensor unit integrated in the stairlift device. The present disclosure also refers to a corresponding method for collision prevention in such stairlift devices. In particular, the present disclosure refers to devices and methods according to features of the respective present independent claim.

### BACKGROUND

Stairlifts for individuals or cargo/loads are commonly used e.g. in private houses, especially also in context with passenger transportation of physically hampered persons. For a user of a stairlift driving up/down the stairs, there remains a likelihood/risk of objects or individuals (persons/animals, further referred to as object likewise) occurring in the surrounding of, in particular in front of the stairlift and colliding with the stairlift; probably, a/the user will not be able to notice any such collision risk. Thus, there is a high risk the user (. the stairlift) driving into that object (individual) and damaging the stairlift or object or even hurting an individual.

In order to cope with that risk, until now, some current stairlift designs provide for constructive structural mitigations allowing to prevent or at least diminish such a risk of damage/injury. E.g., the stairlift's drive exhibits rounded edges which shall guide any object aside when contacted by the stairlift during travel motion, and/or the stairlift's chair (including its footrest e.g., chairleg) exhibits a detection mechanism which may initiate specific measures when encountering an impact force (object already contacting the stairlift) higher than a predefined level (e.g. higher than 50 N) in travel direction. Although such provisions for preventing any damage in context with objects being arranged on the stairs or in any other section of the travel path already exist, there remains a certain risk of serious collision and damage especially with/of the stairlift's drive. Therefore, there is a need for further improved systems and methods in context with that risk of collision/damage.

EP 2 825 494 B1 describes a stairlift comprising a safety device having a CPU and being configured for communicating status information on stair lift components and/or objects in the vicinity of the stair lift, wherein the safety device is configured for deciding whether or to move along the rail.

US 2010/314201 A1 further discloses a stairlift with a defined path, wherein the path ahead of the moving stairlift is monitored by the means of one or more obstruction detection sensors and speed of the stairlift is controlled according to the monitoring.

Previously known configurations do not yet sufficiently allow for extensively checking and minimizing any risk of collision during the ride, i.e., along the whole path of motion of the stairlift.

### SUMMARY

It is an object of the present disclosure to provide for enhanced collision prevention for stairlift devices, especially in context with passenger transport. In particular, a/the object of the present disclosure is to provide for apparatuses and methods allowing for avoiding any collision before any impact, in order to further reduce the risk of damage/injury.

The object of the disclosure is solved by the features of the independent main claims. Advantageous features are indicated in the subclaims. The features of the subclaims can be combined with the features of the main claims and further subclaims.

In particular, the object is therefore solved by a stairlift device configured for collision detection based on at least one sensor unit integrated in the stairlift device, wherein the at least one sensor unit is configured and arranged for scanning the area surrounding the stairlift device and/or in travel direction and for detecting an object (in the surrounding environment in travel direction), wherein the stairlift device is configured for collision prevention based on (momentary) sensor data of at least one sensor of the sensor unit, wherein the stairlift device exhibits or includes a control unit coupled with the at least one sensor and with at least one drive or actuator of the stairlift device, wherein the stairlift device is configured for stopping or at least decelerating the at least one drive or actuator based on (momentary) sensor data, especially depending on at least one distance threshold, especially depending on the direction and/or speed of travel. In particular, the at least one sensor unit is configured and arranged for scanning the area in front of the stairlift device. The surrounding includes e.g. the front, the lower side or the back of the stairlift. This configuration also allows for systematic checking of the route of travel; the user thus supported in his responsibility for recognition of any potentially colliding object.

Based on the interaction between sensor unit and control unit and the at least one drive or actuator, the present disclosure provides for collision prevention allowing for actively influencing the advance/advancing (kind of driving) or relative alignment of the stairlift device or a drive unit.

In other words: To prevent any collision in the surrounding of the stairlift in travel direction, especially in front of the stairlift's drive (or in addition in a lateral sector, also), at least one sensor, especially several contactless sensors, can be integrated in the stairlift's outer housing parts (especially in the drive's outer housing parts) and can be connected with the stairlift's control unit/system in such a manner that these sensors are configured to scan the near area in the surrounding of the stairlift in front of the stairlift's drive (or in addition in a lateral sector) and are configured to detect any object (individual) being too close to the stairlift (especially by defining at least one threshold, e.g. depending on the direction and/or speed of travel) and are configured to provide for respective sensor data which may initiate respective control commands (e.g., stopping or at least decelerating at least one motor or actuator). In particular, the sensors are at least partially provided in the form of proximity sensors, e.g. as distance measuring sensors, LIDAR, ultrasonic devices (sound waves emitting and receiving devices) including any such (distance) measuring technique (e.g. by determining ranges/distances by targeting an object, e.g. with at least one laser or acoustic emitter, and measuring the time for the reflected light/sound/radiation to return to the receiving unit). Thus, the sensor unit may include light/radiation/sound emitting configurations and light/radiation/sound receiving configurations. Sensors may e.g. be located at a front side of any part of the stairlift as predescribed or at a lower side of a part of the stairlift, e.g. below the footrest to scan the lower surroundings of the stairlift. Sensors may also be located on a backside of any part of the stairlift to detect an object approaching to the stairlift and to take countermeasures accordingly, e.g. swivelling to avoid collision.

During installation of the stairlift, the system is programmed (especially in a self-learning manner) by driving up and down the stairs (driving/advancing along the rail) and by measuring (and logging) all potentially desirable proximities and specific conditions on the track, thereby providing for a plurality of proximity values (e.g. for storing them in a data storage unit of the control unit). After installation, these acquired proximity values can be programmed into the system (included to a control process defined by the control unit) to act as at least one trigger value.

In case any of the stairlift's sensors will detect an abnormal (close) proximity during the stairlift's ride, the stairlift's drive will be decelerated (especially in order to stop the drive/motion) based on at least one control command in order to keep at least a minimal distance to the object. Further, in addition or as an alternative, collision prevention can be carried out (also) based on at least one further control command for execution of a swivel motion of the stairlift in such a manner that minimal distance to the object is established/ensured, i.e., effecting the stairlift to swivel away from collision zone (swivelling around at least one swivel axis defined by the stairlift's kinematics and drive(s)). Insofar as the sensor is contactless, recognition of an object is possible without any contact between the sensor and the object and accordingly without any mechanical affection between the object and the stairlift.

According to the present disclosure, when referring to “collision detection” (detection of potential collision), it is likewise referred to detection/evaluation of a risk of collision.

According to one embodiment the stairlift device is configured for (autonomously) ensuring a minimum distance between the stairlift device, especially a/the stairlift's drive unit, and a/the object detected within the area surrounding the stairlift device (. in travel direction), by timely stopping or at least decelerating (autonomously) the at least one drive or actuator based on (momentary) sensor data, depending on at least one predefined distance threshold stored in a data storage unit of the control unit or accessible by the control unit (e.g. data stored in a wirelessly accessible cloud), especially depending on the direction and/or speed of travel. This autonomous distance control may also ensure secure transportation. In particular, the process of actuating/stopping at least one drive/motor can be initiated by predefined trigger values, especially based on individual trigger values defined specifically for an individual installation/system. Individual trigger values can be stored in the data storage unit.

According to one embodiment the stairlift device is configured for locating a/the detected object within at least one angular segment, e.g. within an angular segment of 5° or 10° of a field of view of the at least one sensor. This kind of evaluation of the object's relative position may also provide for more accurate and appropriate reaction of the system, i.e., deceleration or stopping might be initiated only in case the risk of colliding with object is quite high. Also, e.g. in case the object resides in an angular segment which is arranged quite laterally with respect to the stairlift device, the control unit may decide to initiate e.g. a swivel motion instead of stopping the main drive.

According to one embodiment the sensor unit exhibits at least one scanning sensor (scanner) having a field of view of at least 45°. In other embodiments, at least 60°. This range also facilitates extensive/broad scanning of the relevant environment in at least one travelling direction. In particular, the field of view may extend from the rail to a transverse/crosswise bearing (abeam, at least approximately), or only to about 60° with respect to the travelling direction, and can be subdivided in e.g. 10 to 15 angular segments which can be evaluated individually, based on specific sensor data individually referring to each of these segments. The stairlift device exhibits at least two of such scanning sensors being aligned in opposite travelling directions; alternatively, the at least one scanning sensor can be pivotably arranged at the stairlift device and can be configured to auto-align depending on the (momentary) travelling direction, e.g. based on a rotary encoder or turning drive controlled by the control unit.

According to one embodiment the stairlift device is configured for locating a/the detected object within at least one specific/specified distance segment, e.g. within a distance segment corresponding to the depth of a/the steps which are to be surmounted/overcome by the stairlift device. This kind of evaluation also facilitates control based on a predefined raster e.g. matching with the number of stairs, thereby referring more easily to a specific position or level of an object. The distance segment may also be predefined according to the sensing unit's resolution.

According to one embodiment at least one sensor of the sensor unit is a wireless sensor. This kind of sensor technology also facilitated setup change and backfitting of the sensor components in already existing (built-in) stairlifts and facilitates communication with the control unit irrespective of any wired connection. Also, the relative position at the stairlift device, especially on the drive unit, can be chosen in quite flexible manner. The control unit exhibits a communication module configured for wirelessly communicating with the wireless sensor(s). According to the present disclosure, a wireless sensor may both be configured for wirelessly detecting an object and for being implemented wirelessly within the stairlift device. The latter feature is realized e.g. in context with stairlift device for which the sensing system is retrofitted (at least in parts).

According to one embodiment at least one sensor of the sensor unit is integrated in at least one outer housing part of the stairlift device, especially in an outer housing part of the at least one drive. This configuration also allows for implementation of different kinds of sensors, e.g. optically sensing sensors.

According to one embodiment at least one sensor of the sensor unit exhibits a field of view at least scanning (relating to) an area below the outer housing parts, especially also below the drive unit. By directing at least one sensor to an area directly below the structural parts of the stairlift device, detection of any risk of collision can be carried out in enhanced manner also in view of any unexpected object or situation increasing a risk of an object wedging between the floor/ground and the drive unit or any further lower structural parts of the stairlift device.

According to one embodiment the stairlift device exhibits a plurality of sensors, especially contactless sensors, including distance measuring sensors, especially proximity sensors, wherein the sensors are arranged/integrated in at least one outer housing part of the at least one drive, wherein the sensors are configured to measure a distance/proximity in different directions and to provide respective directional (direction-specific) distance values to the control unit, wherein the sensors have individual fields of view, especially with each field of view in the range of at least 45°, and in some embodiments, at least 60°, especially based on a sector resolution (angular segment) of at least 5°. This configuration also facilitates sensory integration and accurate/appropriate evaluation of sensor data.

According to one embodiment the stairlift device is configured for adapting/increasing the relative distance between the stairlift device and a/the detected object, by activating or stopping or at least decelerating at least one further drive or actuator (e.g. by actuating a swivel motion and/or a tilting motion of a/the chair of the stairlift device) based on (momentary) sensor data, especially depending on at least one distance threshold, especially depending on the direction and/or speed of travel. This also allows for active collision prevention without completely stopping functioning of the stairlift device, e.g. by actively driving around an obstacle, e.g. also by implying a lifting/levelling drive of the stairlift device. This kind of control can also be implemented in context with bulkhead distance monitoring.

According to one embodiment the stairlift device includes at least one loudspeaker, wherein the stairlift device is configured to output at least one specific sound or at least one voice spoken massage by the at least one loudspeaker before and/or during stopping or decelerating the at least one drive or actuator and/or activating, stopping or decelerating the at least one further drive or actuator based on sensor data. A specific sound may be an alarm sound or a sound having a specific loudness depending on the distance to the object. A voice spoken massages may be directed to explain the behavior of the stairlift device to a person to avoid the person to be surprised by unexpected behavior such that the person can understand the behavior and build up trust in the stairlift device. E.g. acceleration, deceleration or swivel operation may be communicated to the user by the voice spoken massage. Thus, the stairlift device may be configured to output a specific sound or a voice spoken massage with a warning/explanatory intention before actuating any such operation of the stairlift device, such as immediate before any such operation. By explaining the behavior of the stairlift device, a disruptive reaction of the user to a misunderstood behavior of the stairlift device and a resulting fault or danger may be avoided.

The control unit is coupled with the at least one loudspeaker. Thus, the output of the specific sound or voice spoken massage may be affected/controlled/initiated by the control unit based on sensor data, e.g. after detection of an object/potential collision with an object and e.g. before initiation an activation, stop or deceleration of any drive. As the control unit is coupled with the at least one sensor and with at least one drive or actuator and/or the further drive or actuator, specific sound or voice spoken massages may be affected/controlled/initiated in good time-coordination with detection and/or activation, stop or deceleration of any drive.

Further, in some embodiments, the stairlift device is configured to output at least one warning regarding the activation, stop or deceleration of the at least one drive or actuator and/or the at least one further drive or actuator as a specific sound or a voice spoken massage by the at least one loudspeaker. Thus, an accoring voice spoken massage may e.g. be “stairlift will decelerate/stop/swivel now”, “please hold fast for security measures” or the like. Thus, a person using the stairlift device may be prepared to behave in favor of the measures taken by the stairlift device and may be hold off taking any disruptive counter measures or the like due to misunderstanding of the situation.

Further, in some embodiments, the stairlift device is configured to output at least one information of the reason for activating, stopping or decelerating the at least one drive or actuator and/or the at least one further drive or actuator as a voice spoken massage by the at least one loudspeaker. Thus, the voice spoken massage may e.g. be “object detected, stairlift will decelerate/stop/swivel now”, “stairlift will stop to prevent collision”, “please hold fast for collision prevention” or the like. This measure advantageously further increased the understanding of the person using the stairlift device in favor of avoiding disruptive behavior.

According to embodiments, certain features of the specific sound and/or voice spoken massages may be adapted to a situation, e.g. the loudness, the used voice, the playback speed, the intonation and/or language of the voice spoken massages may be selected accordingly. E.g. intonation of the vice spoken massage may be more firmly and playback speed may be faster in case, a sharp break is necessary for collision avoidance.

In particular, the above mentioned object is therefore also solved by a stairlift control unit configured for controlling a stairlift device, especially a stairlift device as described above, wherein the stairlift control unit is configured for collision detection based on sensor data of at least one sensor unit, wherein the stairlift control unit is configured for collision prevention based on the sensor data by actuating, such as stopping or at least decelerating, at least one drive or actuator, such as depending on at least one distance threshold, such as depending on the direction and/or speed of travel of a/the stairlift device. This kind of implementation also allows for efficient realization of the inventive concept in new or in already existing stairlift devices.

In particular, the above mentioned object is therefore also solved by a method for controlling a stairlift device, especially a stairlift device as described above, in context with collision detection and for collision prevention, at least including the following steps: acquiring and providing sensor data to a control unit by scanning the area in the surrounding of the stairlift device or in travel direction, such as by at least one contactless sensor of a sensor unit for detecting an object; detecting a risk of collision by evaluating the sensor data, by comparing the sensor data with respect to at least one distance threshold; preventing collision by controlling at least one drive/actuator of the stairlift device based on evaluated sensor data, by actuating or stopping or decelerating or swivelling or tilting or activating at least one drive or actuator of the stairlift device, depending on at least one distance threshold, depending on the direction and/or speed of travel. This provides for above mentioned advantages, and also in context with already existing (built-in) stairlift devices.

According to one embodiment the method further includes acquisition of proximity values and/or setting of trigger values, in autonomous manner e.g. during test rides along the rail up and down the stair, in conjunction with the step of acquiring and providing sensor data. This also allows for a high degree of individualization for specific installation situations.

According to one embodiment, at least one predefine/predefinable distance value is defined as a trigger value for actuation of the at least one drive or actuator, by referring to at least one specific angular segment of the sensor's field of view, based on proximity values individually acquired along a/the rail defining the path of motion of the stairlift device. This manner of activation of any control measures (manipulation of drives/actuators) also facilitates unhindered operation in case there be no factual risk of collision.

According to one embodiment the method is a computer-implemented method.

In particular, the above mentioned object is therefore also solved by a computer program including instructions which, when the program is executed by a computer, cause the computer to execute the steps of the method described above.

In particular, the above mentioned object is therefore also solved by use of at least one drive or actuator of a stairlift device for controlling the stairlift device in context with collision detection and for collision prevention, use of at least one running drive intended for locomotion or orientation/alignment in a stairlift device as described above, wherein sensor data of at least one sensor is acquired by scanning the area in the surrounding of the stairlift device or in travel direction, wherein the sensor data is evaluated by comparison with at least one distance threshold, wherein the at least one drive or actuator is controlled based on said evaluated sensor data for preventing a collision, namely by actuating or stopping or decelerating or swivelling or tilting or activating the at least one drive or actuator, depending on the direction and/or speed of travel. This provides for above mentioned advantages, also in context with favourable and easy implementation in already existing (built-in) stairlift devices without any elaborate design modifications, especially based on existing drive concepts.

### SHORT DESCRIPTION OF FIGURES

These and other aspects of the present disclosure will also be apparent from and elucidated with reference to the embodiments described hereinafter. Individual features disclosed in the embodiments can constitute alone or in combination an aspect of the present disclosure. Features of the different embodiments can be carried over from one embodiment to another embodiment. In the drawings:

FIG. 1 in schematic representation in a top view a field of view of a stairlift device according to one embodiment;

FIG. 2 in a perspective view the bottom side of a stairlift device according to one embodiment;

FIG. 3A schematically depicts a perspective side view a/the drive unit of a stairlift device according to one embodiment in situations in which collision with an object shall be prevented, and in particular, shows a situation within a lower area of the stair

FIG. 3B schematically depicts a perspective side view a/the drive unit of a stairlift device according to one embodiment in situations in which collision with an object shall be prevented, and in particular, shows a situation within a middle area of the stair;

FIG. 3C schematically depicts a perspective side view a/the drive unit of a stairlift device according to one embodiment in situations in which collision with an object shall be prevented, and in particular, shows a situation at the beginning of an upper landing area of the stair;

FIG. 3D schematically depicts a perspective side view a/the drive unit of a stairlift device according to one embodiment in situations in which collision with an object shall be prevented, and in particular, shows a situation within a lower landing area of the stair

FIG. 3E schematically depicts a perspective side view a/the drive unit of a stairlift device according to one embodiment in situations in which collision with an object shall be prevented, and in particular, shows a situation within an upper landing area of the stair

FIG. 3F schematically depicts a perspective side view a/the drive unit of a stairlift device according to one embodiment in situations in which collision with an object shall be prevented, and in particular, shows a situation within a middle area of the stair, the object is a person's leg;

FIG. 4 in a perspective side view a stairlift device according to one embodiment, arranged at/on a rail along a stair; and

FIG. 5 in schematic representation steps of a collision detection and prevention method according to embodiments.

### DETAILED DESCRIPTION

First, the reference signs are described in general terms; individual reference is made in connection with respective figures.

The present disclosure provides for stairlift devices 10 having a drive unit 11 exhibiting at least one drive or actuator 11.1, wherein outer housing parts 13 ensheath or enclose the stairlift's components. In order to overcome/surmount a stair 1, a user may sit down on a chair 17 e.g., seat 17.1 while putting the feet on a footrest 17.3 which is connected to the seat/chair by a chairleg 17.5. The drive unit 11 may then convey the chair 17 along a rail 3.

In order to allow for detection recognition of objects 5 and for prevention of any (risk of) collision, the stairlift device 10 further includes a sensor unit 15 exhibiting at least one sensor 15.1 (especially contactless sensor) and a stairlift control unit 19 having a data storage unit 19.1, wherein the sensor unit 15 is in communication with the control unit 19, and wherein the control unit 19 is in communication with the at least one drive or actuator 11.1.

The stairlift control unit 19 may be an electronic control unit (ECU), a central processing unit (CPU), and the like, for performing the functions as described herein. As such, the stairlift control unit 19 may be configured to receive, analyze and process sensor data, perform calculations and mathematical functions, convert data, generate data, control system components (e.g., the drive unit 11, the at least one drive or actuator 11.1, and the like), and the like. The stairlift control unit 15 may include one or more processors, and other components, for example one or more memory modules that stores logic that is executable by the one or more processors and a database (e.g., the data storage unit 19.1) based on, for example, based on received sensed data from the sensor unit 15. Each of the one or more processors may be a controller, an integrated circuit, a microchip, central processing unit or any other computing device. The one or more memory modules may be non-transitory computer readable medium and may be configured a RAM, ROM, flash memories, hard drives, and, or any device capable of storing computer-executable instructions, such that the computer-executable instructions can be accessed by the one or more processors.

The computer-executable instructions may include logic or algorithms, written in any programming language of any generation such as, for example machine language that may be directly executed by the processors, or assembly language, object orientated programming, scripting languages, microcode, and the like, that may be compiled or assembled into computer-executable instructions and storage on the one or more memory modules. Alternatively, the computer-executable instructions may be written in hardware description language, such as logic implemented via either a field programmable gate array (FPGA) configuration or an application specific integrated circuit (ASIC), all their equivalents. Accordingly, the systems, methods, processes, and/or computer product programs described herein may be implemented in any conventional computer programming language, as preprogrammed hardware elements, or as a combination of hardware and software components. Further, provided herein is a computer program product for use with or by the control unit and/or a computer that is a central processing unit configured for controlling components of the starilift (e.g., the drive unit 11, the at least one drive or actuator 11.1, and the like). The computer program product may include a computer usable medium having computer readable readable instruction or program code embodied on the computer usable medium.

The data storage unit 19.1 may generally be a data storage device, such as a data server, a data respotiory, a cloud-based sever, a physical storage device, a removable media storage device, or the like. The data storage unit 19.1 may be integrated with the control unit 19, computer, sensor unit 15 (e.g., a component of thereof) or may be a standalone unit.

The drive unit 11 includes at least the following drives or actuators 11.1: main drive for travelling along the rail, swivel drive/actuator, tilting e.g., levelling drive/actuator, lifting drive/actuator; wherein the respective drive/actuator may apply to the whole chair or only to specific components, e.g. to the footrest or armrests or seat. The skilled person may decide which drive concept be most appropriate for individual applications/appliances.

Based on sensor data and interaction between control unit 19 and drive unit 11, the present disclosure allows for the following arrangements, procedures and provisions:

A collision detection is carried out in context with at least one sensor scanning the area surrounding the stairlift device or in travel direction and detecting an object, wherein collision prevention is carried out based on sensor data of the at least one sensor provided to the control unit which controls the drive unit to stop or at least decelerate the at least one drive or actuator, especially depending on at least one distance threshold xt, especially depending on the direction and/or speed of travel. Collision prevention may also include actuating and/or activating at least one drive or actuator, e.g. for positioning the footrest in a higher position. A corresponding method for controlling the stairlift device in context with collision detection and collision prevention may thus include the step S1 (especially first step) of acquiring and providing sensor data to the control unit and the step S2 (especially 2^{nd} step) of detecting a risk of collision by evaluating/comparing the sensor data and the step S3 (especially 3^{rd} step) of preventing collision by controlling at least one drive/actuator of the stairlift device based on evaluated sensor data, especially by actuating or stopping or decelerating or swivelling or tilting or activating at least one drive or actuator of the stairlift device (step S4, especially 4^{th} step).

Optionally, for each individual appliance, a database for comparison of proximity values can be managed individually, by acquiring individual proximity values and/or by setting of individual trigger values (step S5, especially fifth step), which can be done e.g. during test rides and/or during normal operation, e.g. autonomously by activating a respective calibration mode e.g. after a predefined interval.

In particular, at least one desirable proximity is acquired by the sensor unit and stored in the control unit, e.g. a first desirable proximity P1 (e.g. step of lower landing) and a second desirable proximity P2 (e.g. step of upper landing/stairhead).

Each sensor has a field of view a or angular range of e.g. 55 or 60°, and the field of view can be subdivided in a plurality of angular segments al and/or distance segments x1 which can be defined individually according to desired/required accuracy. Thus, any actuation in context with collision prevention can be defined depending on angular information and also distance information depending on individual distance thresholds xt.

The stairlift device 10 further includes a loudspeaker 20, which is connected to the control unit 19 and is configured to output specific sound and/or voice spoken massages, e.g. for warning a person using the stairlift device 10 of an upcoming collision avoidance measure. Also, by a voice spoken massage, the person may be informed about the reason of the measure.

In the figures, (x) designates the travel direction path of motion, and (y) designates the cross direction, and (z) designates the vertical direction e.g., the direction orthogonal to the travel direction and cross direction.

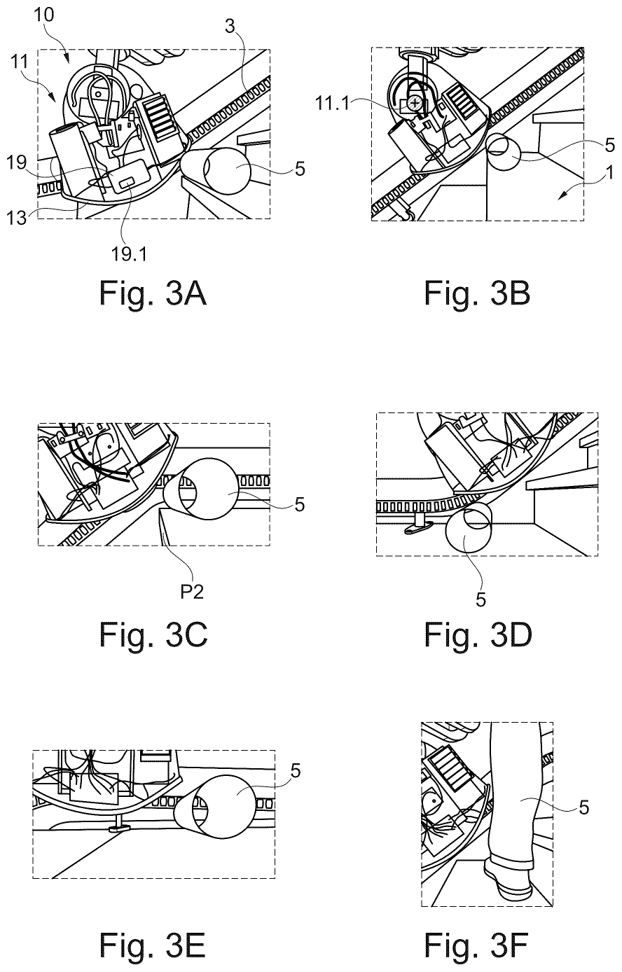

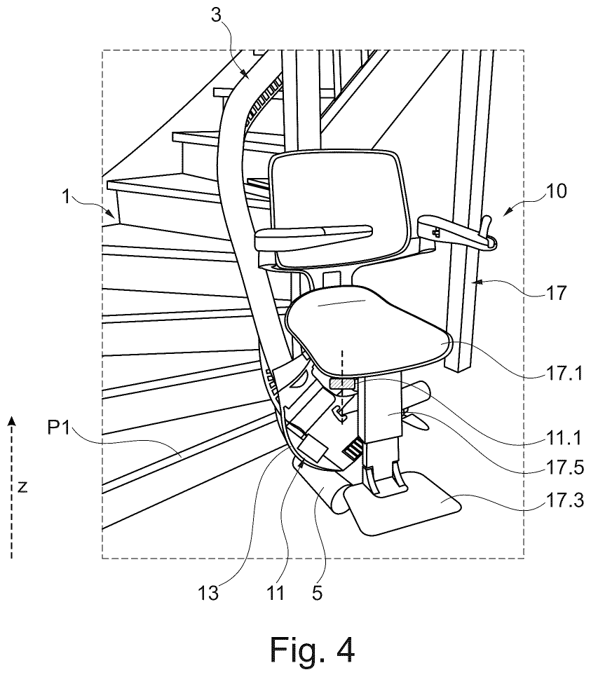

In the figures, the drives/actuators 11.1 of the drive unit 11 are shown only schematically. E.g., FIG. 3B illustrates a tilting drive (effecting rotation around a horizontal axis) and FIG. 4 illustrates a swivelling drive (effecting rotation around a vertical axis).

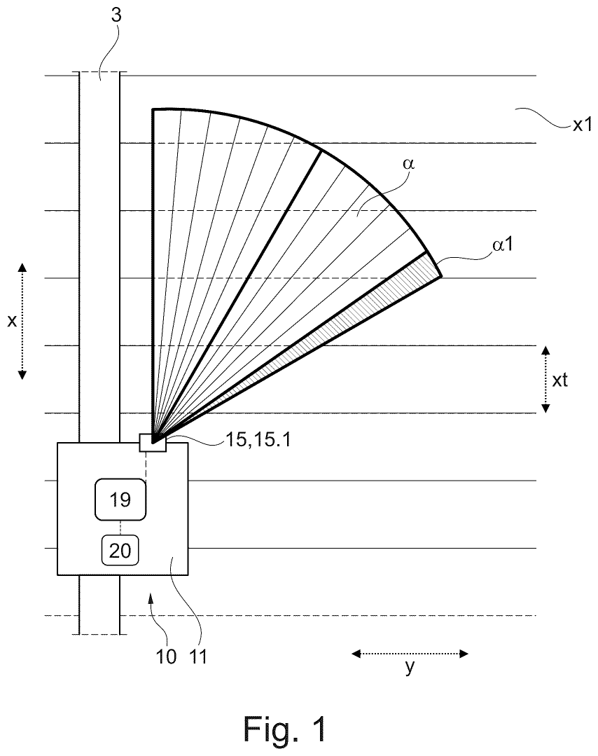

FIG. 1 schematically illustrates the concept of the present disclosure, wherein the at least one sensor 15.1 exhibits a field of view (angular range) a which is subdivided in several segments α1.

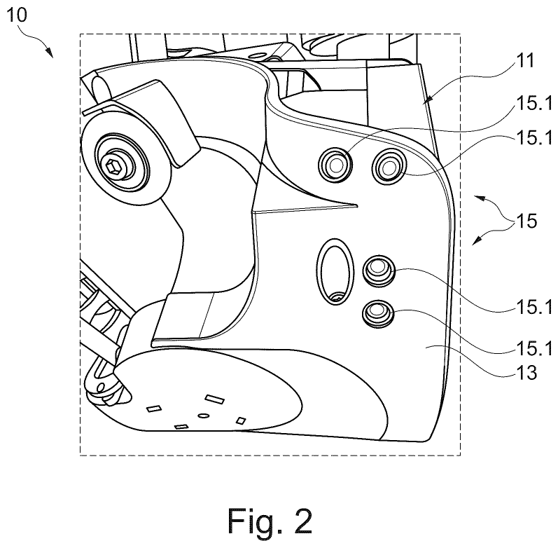

In FIG. 2 an exemplary arrangement of sensors 15.1 is illustrated in more detail. At least some of the sensors are directed to the floor, i.e., theses sensors exhibit a field of view at least scanning (relating to) an area below the outer housing parts, especially also below the drive unit. Such a field of view also facilitates collision prevention in context with at least some of the situations shown in FIG. 3.

In FIG. 3 are shown some situations generating potential risk of collision, wherein a potentially colliding object 5 is arranged at different exemplary relative positions, and wherein the stairlift (especially its drive unit) is aligned in individual manner with respect to the object. In particular, FIG. 3A shows a situation within a lower area of the stair. FIG. 3B shows a situation within a middle area of the stair. FIG. 3C shows a situation at the beginning of an upper landing area of the stair. FIG. 3D shows a situation within a lower landing area of the stair. FIG. 3E shows a situation within an upper landing area of the stair. FIG. 3F shows a situation within a middle area of the stair, wherein the object is a person's leg.

FIG. 4 illustrates a whole stairlift device 10 and also a/the stair 1 and a/the rail 3. One can imagine that a user (not shown) sitting on the chair may not notice a/the object 5 being arranged just in front of the drive unit.

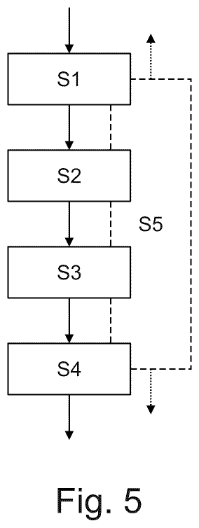

In FIG. 5, it is referred to steps of a method/process according to the present disclosure, wherein step S1 designates acquiring/providing sensor data, and step S2 designates evaluating/comparing sensor data (e.g. with predefined threshold), and step S3 designates controlling at least one drive/actuator based on evaluation, and step S4 designates stopping the stairlift and/or swivelling or tilting or actuating at least one of the stairlift's components, and step S5 designates the acquisition of proximity values and/or the step of setting trigger values (which can be done e.g. during test rides).

1. A stairlift device configured for collision detection comprising:
at least one sensor unit integrated in the stairlift device, wherein the at least one sensor unit is configured and arranged for scanning an area surrounding the stairlift device or in a travel direction and for detecting an object, wherein the stairlift device is configured for collision prevention based on sensor data of at least one sensor of the at least one sensor unit, wherein the stairlift device includes a control unit coupled with the at least one sensor and with at least one drive or actuator of the stairlift device, wherein the stairlift device is configured for stopping or at least decelerating the at least one drive or actuator based on sensor data, depending on at least one distance threshold, depending on the direction and/or speed of travel, wherein the sensor unit exhibits at least one scanning sensor having a field of view of at least 45°,
wherein the stairlift device is configured for locating the detected object within at least one angular segment of 5° or 10° of the field of view of the scanning sensor.

2. The stairlift device according to claim 1, wherein the stairlift device is configured for ensuring a minimum distance between the stairlift device, a drive unit of the starilift device, and the object detected within the area surrounding the stairlift device or in travel direction, by timely stopping or at least decelerating the at least one drive or actuator based on sensor data, depending on at least one predefined distance threshold stored in a data storage unit of the control unit or accessible by the control unit, especially depending on the direction and/or speed of travel.

3.-4. (canceled)

5. The starilift device according to claim 1, wherein the stairlift device is configured for locating the detected object within at least one distance segment such as within a distance segment corresponding to the depth of steps which are to be surmounted by the stairlift device.

6. The stairlift device according to claim 1, wherein the at least one sensor of the sensor unit is a wireless sensor.

7. The stairlift device according to claim 1, wherein the at least one sensor of the sensor unit is integrated in at least one outer housing part of the the at least one drive;
or wherein the at least one sensor of the sensor unit exhibits a field of view at least scanning an area below the outer housing parts and below the at least one drive.

8. The stairlift device according to claim 1, wherein the stairlift device includes a plurality of sensors, the plurality of sensors being contactless sensors configured as distance measuring sensors, wherein the plurality of sensors are integrated in at least one outer housing part of the at least one drive, wherein the plurality of sensors are configured to measure a distance in different directions and to provide respective directional distance values to the control unit, wherein the sensors have individual fields of view in a range of at least 45° based on a sector resolution of at least 5°.

9. The stairlift device according to claim 1, wherein the stairlift device is configured for increasing a relative distance between the stairlift device and the detected object, by activating or stopping or at least decelerating at least one further drive or actuator based on sensor data, depending on the at least one distance threshold and depending on the direction and/or speed of travel.

10. The stairlift device according to claim 9, further comprising:
at least one loudspeaker,
wherein the stairlift device is configured to output at least one specific sound or at least one voice spoken massage by the at least one loudspeaker before or during stopping or decelerating the at least one drive or actuator or activating, stopping or decelerating the at least one further drive or actuator based on sensor data.

11. The stairlift device according to claim 10, wherein the control unit is coupled with the at least one loudspeaker.

12. The stairlift device according to claim 10, wherein the at least one loudspeaker is configured to output at least one warning regarding the activation, stop or deceleration of the at least one drive or actuator or the at least one further drive or actuator as a specific sound or voice spoken message

13. The stairlift device according to claim 10, wherein the at least one loudspeaker is configured to output at least one information of a reason for activating, stopping or decelerating the at least one drive or actuator or the at least one further drive or actuator as a voice spoken message.

14. The stairlift device according to claim 1, wherein:
the stairlift control unit is configured for:
controlling the stairlift device
collision detection based on sensor data of the at least one sensor unit, collision prevention based on the sensor data by actuating, via stopping or at least decelerating, the at least one drive or actuator depending on at least one distance threshold depending on the direction and/or speed of travel of the stairlift device, and
locating the detected object within the at least one angular segment of 5° or 10° of the field of view of the scanning sensor.

15. A method for controlling a stairlift device for collision detection and for collision prevention, at least comprising the following steps:
acquiring and providing sensor data to a control unit by scanning the area surrounding the stairlift device or in travel direction, by at least one contactless sensor of a sensor unit for detecting an object;
detecting a risk of collision by evaluating the sensor data, by comparing the sensor data with respect to at least one distance threshold;
preventing collision by controlling at least one drive or actuator drive of the stairlift device based on evaluated sensor data, by actuating or stopping or decelerating or swivelling or tilting or activating the at least one drive or actuator of the stairlift device depending on the at least one distance threshold on the direction and/or speed of travel.

16. The method according to claim 15, wherein the method further comprises:
acquiring proximity values or setting of trigger values in conjunction with the step of acquiring and providing sensor data.

17. The method according to claim 15, wherein at least one predefined distance value is defined as a trigger value for actuation of the at least one drive or actuator based on proximity values individually acquired along a rail defining a path of motion of the stairlift device.

18. The method according to claim 15, wherein before collision is prevented, at least one specific sound or at least one voice spoken message is output by at least one loudspeaker.

19. A computer program comprising instructions which, when the program is executed by a computer for collision detection and for collision prevention, cause the computer to execute the steps of:
acquiring and providing sensor data to a control unit by scanning the area surrounding the stairlift device or in travel direction, by at least one contactless sensor of a sensor unit for detecting an object;
detecting a risk of collision by evaluating the sensor data, by comparing the sensor data with respect to at least one distance threshold;
preventing collision by controlling at least one drive or actuator drive of the stairlift device based on evaluated sensor data, by actuating or stopping or decelerating or swivelling or tilting or activating the at least one drive or actuator of the stairlift device depending on the at least one distance threshold, on the direction and/or speed of travel.

20. The stairlift device according to claim 1, further comprising:
at least one running drive configured for locomotion or orientation of the-stairlift device,
wherein the use of the at least one drive or actuator of the stairlift device for controlling the stairlift device with collision detection and for collision prevention, and with use of the at least one running drive wherein sensor data of at least one sensor is acquired by scanning the area surrounding the stairlift device or in the travel direction, wherein the sensor data is evaluated by comparison with at least one distance threshold, wherein the at least one drive or actuator is controlled based on said evaluated sensor data for preventing a collision by actuating or stopping or decelerating or swivelling or tilting or activating the at least one drive or actuator depending on the direction and/or speed of travel.
